(19) United States
(12) Patent Application Publication
(10) Pub. No.: US 2009/0143231 A1
(43) Pub. Date: Jun. 4, 2009

(54) Method For Enhancing the Quality of Green Leaf Vegetables

(75) Inventors: David Payne, Whittlesford (GB); Elizabeth Hall, Whittlesford (GB); Bruce McKenzie, Whittlesford (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA LIMITED, Guildford, Surrey (GB)

(21) Appl. No.: 11/911,829

(22) PCT Filed: Apr. 13, 2006
(86) PCT No.: PCT/GB2006/001381

§ 371 Date: Oct. 18, 2007

(30) Foreign Application Priority Data
Apr. 25, 2005 (GB) 0508302.7

(51) Int. Cl. A01N 37/44

(52) U.S. Cl. 504/315; 800/295

(57) ABSTRACT

The present invention relates, inter alia, to a method for producing a green leaf vegetable having an extended shelf life or enhanced organoleptic properties, or both, which comprises applying to the foliage of a green leaf vegetable during its growing period an effective amount of a strobilurin or strobilurin-type fungicide. In particular, the present invention relates to a method for producing lettuce having an extended shelf life or enhanced organoleptic properties.

This invention relates to a method for producing green leaf vegetables, especially lettuce, having an enhanced quality and extended shelf life.

The quality and appearance of fresh produce like lettuce is key to both the consumer and in turn to the retail and horticultural industries. Deterioration in the appearance or texture of produce through aging reduces in-store shelf life and may deter consumers from buying the produce. This reduces sales revenue and increases waste at the retailer level.

Lettuce is grown both in the field and in glasshouses. Crops grown in the field will normally be grown from glasshouse-grown transplants, but can sometimes be direct-drilled. Field grown leafy lettuce takes about seven weeks from transplanting to maturity and head lettuce varieties take about eleven weeks. In the glasshouse, head lettuce is seeded in peat blocks and then transplanted to the final growing media; this takes two to three weeks during summer and four to six weeks during winter. The whole process takes six to seven weeks in summer and ten to twelve weeks in winter. The crops are harvested either mechanically or by hand cutting. The harvested lettuce crop is transported to the pack-house where it is cooled immediately.

For ordinary lettuce, the shelf-life will vary depending on variety and storage conditions but typically shelf-life may be estimated as between two and four weeks in refrigerated conditions or between five and seven days at ambient temperature, which is how most product is stored within supermarkets. Varieties differ greatly: Little Gem is a long-lasting variety but Lollo Rosso has a shelf life of only around five days.

A major problem faced by the lettuce industry is discolouration known as ‘pinking’ (pink-red discolouration of aged, wounded or cut surfaces), which reduces the shelf life of whole and, especially, processed lettuce. Pinking is caused by a series of enzymatic and non-enzymatic oxidative processes acting on phenolics such as chlorogenic acid, normally present in lettuce. The process of discolouration is accelerated as lettuce ages (senesces) and when the lettuce is cut or damaged, leading to an even shorter shelf life. Wounding of lettuce may occur during harvesting, handling and during processing of fresh cut lettuce. Reduced shelf life and discolouration is of particular relevance for the bagged salads market; it is recognised to reduce consumer acceptance of this product. The shelf life of these bagged salads is around five days.

It is believed by the industry and retailers that improvements in shelf life could boost sales of bagged lettuce through a greater consumer acceptance of the product. The perception held by retailers is that there are consumers whom are reluctant to buy the product, whilst others, having bought the product will not re-purchase.

In order to attempt to overcome this problem, bagged salads are now packed in Modified Atmosphere Packaging (MAP), which uses a nitrogen enriched atmosphere to reduce oxidation and thus discolouration. Other methods for improving shelf-life of whole lettuce have been employed, including using the use of humidified cold stores and the use of plant hormones namely giberellin, benzyladenine, methyl cyclopropene and indole-3-acetic acid in combination with (MAP). Research is aimed at developing gene technologies based on identifying the enzymes responsible for the pinking.

The shelf-life of other green leaf vegetables may be limited in other ways. For example, broccoli and cabbage may lose their green colour (through chlorophyll degradation) and turn yellow or grey, or develop unpleasant, bitter flavours, or in the case of broccoli, develop a cabbage-like flavour.

The present invention is based on the discovery that the quality of green leaf vegetables, especially lettuce, can be improved and their shelf life extended by the pre-harvest treatment of a green leaf vegetable crop with a strobilurin or strobilurin-type fungicide.

Thus, according to the present invention, there is provided a method for producing a green leaf vegetable having an extended shelf life or enhanced organoleptic properties, or both, which comprises applying to the foliage of a green leaf vegetable during its growing period an effective amount of a strobilurin or strobilurin-type fungicide.

By green leaf vegetable is meant any vegetable which produces edible green leaves including, but not limited to, brussel sprouts, broccoli, cabbage, celery, chard (including Swiss chard), chicory, collards, culinary herbs, dandelions, endive, escarole, garden cress, kale, lettuce, mustard, New Zealand spinach, pak choi, parsley, radicchio, spinach and watercress. The invention is, however, of particular importance when applied to lettuce, i.e. any member of the Lactuca family, and especially to the cultivated species Lactuca sativa. This species includes the varieties: Crisphead (Iceburg types), Batavian or French crisp or Summer crisp types, Butterhead types, Bibb types such as Little Gem, Leaf types such as Lollo Rosso, Oak Leaf types, Cos (Romaine) types, Stem lettuce and Mesclun mix greens. Particularly preferred varieties of lettuce include Crisphead (Iceburg types), Bibb types such as Little Gem and Leaf types such as Lollo Rosso.

Strobilurin and strobilurin-type fungicides are a well-known class of fungicides that act by inhibiting mitochondrial respiration by blocking electron transfer between cytochrome b and cytochrome c₁ at the ubiquinol oxidising site. They include the methoxyacrylate strobilurins such as azoxystrobin and picoxystrobin, the oximinoacetate strobilurins such as kresoxim-methyl and trifloxystrobin, the oximinoacetamide strobilurins such as dimoxystrobin, metominostrobin, orysastrobin (BAS 520) and the strobilurin of the formula:

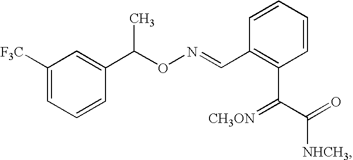

the dihydrodioxazine strobilurins such as fluoxastrobin, the methoxycarbamate strobilurins such as pyraclostrobin, the strobilurin of the formula:

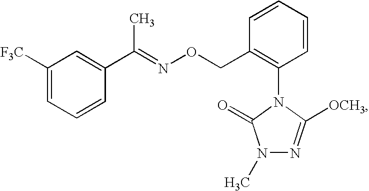

the imidazolinones strobilurin-types such as fenamidone, and the oxazolidinedione strobilurin-types such as famoxadone. Of particular interest is azoxystrobin.

The strobilurin or strobilurin-type fungicide may be applied one or more times to the green leaf vegetable during its growing period. Optionally, it may be applied in addition to one or more other fungicides that may be used to combat fungal infections of the vegetable or in addition to one or more insecticides that may be used to combat insect infestations of the vegetable. For instance, in the case of its application to lettuce, the strobilurin or strobilurin-type fungicide is typically applied three times during the growing period; firstly in combination with the fungicide iprodione, secondly in combination with a metalaxyl/mancozeb mixed fungicide and thirdly in combination with the fungicide fosetyl-aluminium. These applications are typically made one, three and five weeks, respectively, after planting.

The amount of strobilurin or strobilurin-type fungicide applied will depend, inter alia, on the number of applications made during the growing period, on the particular fungicide used and on how the fungicide is formulated. A skilled person will be able to determine the amount without undue experimentation. Typically it will be at about the level the strobilurin is normally applied as a fungicide. In the case of azoxystrobin, which is sold in the form of a suspension concentrate (the commercial products Amistar™ or Ortiva™ are sold as suspension concentrates containing 250 g/l azoxystrobin) 100 to 400 g/ha, for example 200 to 300 g/ha, typically 250 g/ha, would be an effective amount.

The strobilurin or strobilurin-type fungicide may be used in unmodified form but will normally be used in the form of a formulation, in which it is mixed with a carrier, surfactant and/or other application-promoting adjuvant of the type customarily employed in agrochenmical formulation technology.

Suitable carriers and adjuvants may be solid or liquid and are, for example, natural or regenerated mineral substances, solvents, dispersants, wetting agents, tackifiers, thickeners, binders or fertilisers. They are conveniently formulated in known manner to form, for example, emulsifiable concentrates, coatable pastes, directly sprayable or dilutable solutions, dilute emulsions, wettable powders, soluble powders, dusts, granules or capsules, for instance by encapsulation in polymers substances. As with the nature of the composition, the method of application, such as spraying, atomising, dusting, scattering, coating or pouring, is chosen in accordance with the prevailing circumstances.

The formulations may be prepared in known manner, typically by intimately mixing, grinding and/or extruding the strobilurin or strobilurin-type fungicide with an extender, for example, a solvent or a solid or liquid carrier and, where appropriate, one or more surface-active compounds (surfactants).

The agrochemical composition will usually comprise from 0.1 to 99%, preferably from 0.1 to 95%, of the strobilurin or strobilurin-type fungicide and from 99.9 to 1%, preferably 99.9 to 5%, of a solid or liquid carrier and/or adjuvant, and 0 to 25%, preferably, 0.1 to 25%, of a surfactant.

Whereas commercial products or wet or dry dressings will preferably be formulated as concentrates, the end user will normally use diluted formulations for developing plants.

The solid carriers typically used for dusts and dispersible powders are calcite, talcum, kaolin, montmorillonite and attapulgite, highly dispersed silicic acid or absorbent polymers. Suitable granulated adsorptive granular carriers are pumice, broken brick, sepiolite and bentonite, and suitable non-sorptive carriers are typically calcite and dolomite.

Depending on the nature of the particular strobilurin or strobilurin-type fungicide to be formulated, suitable surface-active compounds are non-ionic, cationic and/or anionic surfactants having good emulsifying, dispersing and/or wetting properties. The term “surfactant” will also be understood to include a mixture of surfactants.

The surfactants customarily employed in formulation technology may be found in the following literature: “McCutcheon's Detergents and Emulsifiers Annual”, MC Publishing Corp., Glen Rock, N.J., 1988; and M. and J. Ash, “Encyclopedia of Surfactants”, Vol. I-III, Chemical Publishing Co., New York, 1980-1981.

In one particular aspect of the invention, there is provided a method for producing lettuce, especially the species Lactuca sativa, having an extended shelf life or enhanced organoleptic properties, or both, which comprises applying to the foliage of the lettuce during its growing period an effective amount of a strobilurin or strobilurin-type fungicide.

In another aspect of the invention, there is provided a method for producing lettuce, especially the species Lactuca sativa, having an extended shelf life or enhanced organoleptic properties, or both, which comprises applying to the foliage of the lettuce during its growing period an effective amount of the fungicide azoxystrobin.

In yet another aspect of the invention, there is provided a method for producing a green leaf vegetable having an extended shelf life or enhanced organoleptic properties, or both, which comprises applying to the foliage of a green leaf vegetable during its growing period an effective amount of the fungicide azoxystrobin.

In yet another aspect of the invention, there is provided a green leaf vegetable, especially a lettuce, produced from a crop treated with an effective amount of a shelf-life-extending or organoleptic property-enhancing amount of a strobilurin or strobilurin-type fungicide, especially azoxystrobin.

The invention is illustrated by the following Examples.

### EXAMPLES

### Example 1

In a commercial lettuce crop, two varieties of lettuce “Little Gem” and “Lollo Rosso” were subjected to two treatment programmes. The first programme was a standard fungicide programme entailing a treatment of the lettuce plants with (1) ‘Roval Flo’ iprodione fungicide at a rate of 2.31/ha, one week after planting; (2) ‘Fubol Gold’ metalaxyl/mancozeb mixture fungicide at a rate of 1.9 kg/ha, three weeks after planting; and (3) ‘Aliette 80WG’ fosetyl-aluminium fungicide at a rate of 30 g/100 m², five weeks after planting. The produce was harvested seven weeks after planting, in the case of “Little Gem”, and eight weeks after planting, in the case of “Lollo Rosso”. The second programme was the same as the first standard programme except that each of the standard fungicides was applied in combination with ‘Amistar’ azoxystrobin fungicide (a suspension concentrate containing 250 g/l azoxystrobin) at a rate of 1.0 l/ha. With two varieties of lettuces each being subjected to two treatment programmes, this meant that there were four different trials. Each trial was conducted in four replicates, each replicate comprising at least sixteen lettuces.

Post-harvest assessments of all the trial crops were made at Day 1 and Day 5 (following 5 days storage at 4° C. in the dark). Lettuce samples were assessed for sensory quality (colour, texture, flavour) and analysed for content of pigments (chlorophyll, carotenoids, phenolics and anthocyanins specifically) and antioxidative activity.

In summary the results showed that, in “Little Gem”, treatment with ‘Amistar’ appeared to:
1. increase growth rates, assessed visually (thus attaining maximum biomass earlier and maturing earlier); and
2. reduce pink discolouration in the outer stalks after storage; and in “Lollo Rosso”, treatment with ‘Amistar’ appeared to:
1. increase growth rates and ‘redness’ in Lollo Rosso, assessed visually;
2. improve the crispness and juiciness in some samples; and
3. increase antioxidant capacity.

### Example 2

In a commercial lettuce crop, the Iceberg variety of lettuce was subjected to two treatment programmes. The first programme was a standard fungicide programme entailing a treatment of the lettuce plants with (1) ‘Roval Flo’ iprodione fungicide at a rate of 2.3 l/ha, 10 days after planting; (2) ‘Fubol Gold’ metalaxyl/mancozeb mixture fungicide at a rate of 1.9 kg/ha, 21 days after planting; and (3) ‘Aliette 80WG’ fosetyl-aluminium fungicide at a rate of 30 g/100 m², 32 days after planting. The produce was harvested earlier (day 41), later (day 48) and at the same time as the commercial crop (day 45). The second programme was the same as the first standard programme except that the day 10 and day 32 standard fungicides applications were carried out in combination with ‘Amistar™’ azoxystrobin fungicide (a suspension concentrate containing 250 g/l azoxystrobin) at a rate of 1.0 l/ha. Each treatment was conducted in three replicates, each replicate consisting of 8 rows of 10 plants. Each harvest was made from each replicate by selecting 12 lettuce heads at random per replicate from the six central rows.

After harvest, the lettuce heads were trimmed to industry standards and the total weight for the 12 heads was recorded. Lettuces were then processed by shredding (12 mm shred size), treatment with 80-100 ppm chlorine and bagging and storage under refrigerated modified atmosphere (5% O₂/5% CO₂). Lettuce samples were assessed (i) within 24 hours of harvest, (ii) after 3 days of chilled storage and (iii) after 6 days of chilled storage by three quality assessors who graded the sensory quality (appearance, flavour and texture) of each sample.

In summary, the results showed that there were no significant differences in the weights of samples either treated or not treated with Amistar™. In addition, there were no visual, differences apparent between the treated and untreated lettuce in the field.

In terms of sensory quality, in the early harvest, Amistar™ had no effect on flavour at harvest but, 3 days after harvest, 67% of the Amistar™-treated lettuce had less of a hot, watercress flavour compared with control lettuce while 33% were slightly bitter with a hot aftertaste and, 6 days after harvest, 67% of Amistar™-treated lettuce had retained a better flavour (were less weak and were sweeter) than control lettuce while 33% were less sweet and had a ‘slightly stored’ taste.

In the normal harvest samples, at harvest, 33% of Amistar™-treated lettuce were brighter and more moist than control lettuce, the remainder did not differ from the control. In addition, 67% of Amistar™-treated lettuce were less bitter than control lettuce while the remainder did not differ from the control. At 3 days post-harvest, 33% of Amistar™-treated lettuce had a better flavour than the control while the remainder did not differ.

In the late harvest sample, at harvest, 67% of Amistar™-treated lettuce were less bitter, more sweet and tasted fresher than control lettuce while the remainder did not differ from the control. At 3 days post harvest, 100% of Amistar™-treated lettuce scored highly for appearance with no discoloration seen while 33% of control lettuce showed pinking at this stage. In addition, 100% of Amistar™-treated lettuce had a stronger lettuce flavour than the control lettuce which were uniformly slightly weak flavoured, slightly sweet and with slightly bitter taste. At 6 days post harvest, 67% of the Amistar™-treated lettuce had retained a better flavour compared to controls and were more crisp, while the remained did not differ from the control.

In conclusion, Amistar™ conferred generally positive effects on lettuce flavour and appearance at harvest and throughout storage, which manifested as fresher, less bitter, sweeter and stronger flavour along with reduced discoloration. It is noted that, given the conditions the lettuces were stored in, little discoloration was expected in 6 days—the effect of Amistar™-treatment may well have been even more marked if storage was for longer.

1. A method for producing a green leaf vegetable having an extended shelf life or enhanced organoleptic properties, or both, which comprises applying to the foliage of a green leaf vegetable during its growing period an effective amount of a strobilurin or strobilurin-type fungicide.

2. A method according to claim 1 wherein the green leaf vegetable is lettuce.

3. A method according to claim 2 wherein the lettuce is an Iceberg, Little Gem or Lollo Roso variety.

4. A method according to claim 1 wherein the strobilurin or strobilurin-type fungicide is azoxystrobin.

5. A method for producing lettuce, especially the species Lactuca sativa, having an extended shelf life or enhanced organoleptic properties, or both, which comprises applying to the foliage of the lettuce during its growing period an effective amount of a strobilurin or strobilurin-type fungicide.

6. A method for producing lettuce, especially the species Lactuca sativa, having an extended shelf life or enhanced organoleptic properties, or both, which comprises applying to the foliage of the lettuce during its growing period an effective amount of the fungicide azoxystrobin.

7. A method according to claim 6 wherein the lettuce is an Iceberg, Little Gem or Lollo Rosso variety.

8. A green leaf vegetable produced from a crop treated with an effective amount of a shelf-life-extending or organoleptic property-enhancing amount of a strobilurin or strobilurin-type fungicide.
